(19) United States
(12) Patent Application Publication
(10) Pub. No.: US 2016/0086480 A1
(43) Pub. Date: Mar. 24, 2016

(54) CRIME EVIDENCE PROVIDER CUM HELP SEEKER

(71) Applicant: Muthuraj RAJAMANI, (US)

(72) Inventor: Muthuraj RAJAMANI, Chennai (IN)

(21) Appl. No.: 14/785,326

(22) PCT Filed: Apr. 17, 2014
(86) PCT No.: PCT/IN2014/000249

§ 371 Date: Oct. 17, 2015

(30) Foreign Application Priority Data
Apr. 19, 2013 (IN) 1733/CHE/2013

(51) Int. Cl. G08B 25/01; G08B 21/02

(52) U.S. Cl. CPC G08B 25/016; G08B 21/02

(57) ABSTRACT

The existing invention is crime evidence provider cum help seeker where the system is basically designed over cognitive model to give the machine the required intelligence of being situation aware of pervasive environment. The strength of the system will be in its design of integrating cognitive model with mobile and pervasive computing. For the communication part it uses well established mobile infrastructure. The system is composed of both hardware and software. This design gives the simplistic nature to the system further gives the hope it will comprehend the personal security of everyone by playing the role of presence of police informer cum help seeker, preventing crimes be happened. Without any doubt the system will pose heavy impact and trigger the development of e-governance projects in the departments associated with crime such as police, judiciary, forensic etc.

### FIELD OF INVENTION

The present invention relates to the mobile technology which includes hardware instrument and program for emergency warning systems, mobile communication.

### BACKGROUND OF THE INVENTION

From the studies it is observed that there is increase in the crime rate and complication's incurred due to lack of evidences. The proposed invention is designed to fill the lacuna. The major disadvantages of currently available invention are they are designed to function as general surveillance system for any closed environment. The system continuously collects and transmits the all the information to a server where it is manually processed for threat if any. The currently available model shall affect the privacy of the user and shall be easily misused by any person.

The proposed invention is an intelligent hand held device which can be enhanced to a normal mobile phone. The existing invention can automatically detect the threat or crime situation in the pervasive environment and seeks immediate help from known and/or unknown neighbour and also provides audio/video evidence along with location of the crime to an appropriate authority. The process for crime detection is done in the hand held device which is non-editable by the user to avoid the misuse and prank alerts whereby only appropriate evidence is provided to the authority who can edit to create evidence documents.

### OBJECTIVE OF THE INVENTION

The primary objective of the present invention is the detection of threat in the pervasive environment.

The secondary objective is to seek immediate help from the neighbour by sending messages

The third objective is to provide necessary information as evidence and rest of the collected information are automatically deleted.

The fourth objective is to authenticate the audio video using application controlled situation specific invisible water marking technique.

The final objective of the present invention is to provide some meta-information like map location, date and time of the incidence along with the audio and video evidence to the tightly coupled non mobile device or to an appropriate authority.

### BRIEF DESCRIPTION OF THE PRIOR ART

No such closest prior art is available to the present invention. However there are few patents with similarities of the present invention. US patent No: US20120213212 (A1) describes the “Life streaming” where the method analyses, summarizes and transmits the life experience which is captured by life recorder. A life recorder is a recording device that continuously captures life experiences in image, video and/or audio format. The recordings may be analysed in real time and automatically pushed to one or more target devices allows friends and family to experience the one's life experience as it is happening. This invention works on all situation continuously and all the data is recorded for the future use which may which may affect the privacy of the user and prone to be misused, whereas in the current invention, the model is designed such a way that the program exclusively diagnoses the threat in the pervasive environment. Though the device continuously collects the information it only provides the relevant evidence rest is deleted. The invention is highly secured and cannot be misused, since it restricts any one from editing or altering the information. U.S. Pat. No. 6,807,564 (B1) describes the “panic button ip device” that seeks emergency assistance automatically to an emergency service whereupon activation of the panic button. Whereas in the present invention is an automatic threat detecting device which works without user's requisition for assistance. U.S. Pat. No. 7,714,712 (B2) describes “mobile surveillance” where the system is processed to determine identity contained in the watch list. The object is identified using image analyses and RFID information. Whereas, the present invention is not for surveillance of any specific item or person. The basic objective is to create evidence in case of crime in the vicinity of the device. US U.S. Pat. No. 8,131,012 (B2) describes “Behavioural Recognition system” which relates to the video analysis and recognition of behavioural pattern based on the video data. Whereas the present invention the recognition the behavioural pattern is one of the function but major role is identification of threat scenario and the invention is not restricted to any closed space. US 20060176169 (A1) describes “System for sensing environmental conditions” where this senses the fire condition in the environment and the invention includes several nodes in a region and data collected is transmitted to a base station for processing whereas in the current invention the processing is made in the hand held device itself, no base station is used and in this invention apart from sensor detection the videos are used.

### SUMMARY OF THE INVENTION

The present invention is the fabrication of hardware device supported by software where the device automatically check for the threats, crime, danger, etc and intimates to appropriate authority with appropriate evidence and meantime it automatically seeks help from the nearby node. The program in the device is designed in such a way that it processes the audio/video data from the pervasive environment for any threat and labels with invisible watermark to every evidences.

### DETAILED DESCRIPTION OF THE INVENTION WITH RESPECT TO DRAWING

The invention is the hand held device which is a situation aware crime evidence provider cum help seeker. At the time of an individual get into an unexpected crime scenario this device will sense the situation, identifies the crime scenario and seeks help while simultaneously providing evidence of crime to appropriate authority automatically without manual intervention. Even the group clash or riot can be perceived as collection of individuals get into problem. The device will be capable of working in very generic pervasive environment. The strength of the system will be in its design of integrating cognitive model with mobile and pervasive computing. For the communication part it uses well established mobile infrastructure. The system is composed of both hardware and software. One part of the system component continuously monitors the environment based on certain factors it suspects the crime scenario if any it activates and gives control to the rest of the system components which started perceiving and analyzing the pervasive environment for finer details to confirm the fragrance of crime in the vicinity of its presence.

### Hand Held Mobile Device

The hardware part of the invention comprises of Data collector unit (1), control and processing unit (2) and communication unit (3).

i) Data collector unit collects the data like Global positioning GPS (4), timer (5).
The wireless camera (6) in the Data collector unit continuously records the audio/video (7) recording in frames along with the date and time and the image sensor (8) in the camera processes all the frames to provide clear image during the night shoot. Additional feature in the device is mode button (9) wherein it has night/day option and in-house/exterior environment option. The mode button is used to distinguish night and day timing similarly the inside house environment and outside environment can be selected to avoid unnecessary chaos.

ii) The second component is control and processing unit which comprises

Processor (10), memory (11) and power supply (12).

### Process (13)

The device has suspector unit (14), a hardware component, where it tentatively suspects for threat by checking for any disparity in the audio. If any suspicious situation is detected then the software (15) is triggered thereby cognitive process (16) is initiated, analysing the video/audio proof. The video and audio are parted away and segmented for further processing in pre-processing unit (17). Wherein the video frames are matched with prejudicial video objects from the pre-trained situation dataset (18). Similar to the video the audio is also processed simultaneously by matching with the database (19). If the combinational process confirms the absence of threat then software repeats the whole process continuously. In case of any threat is detected it is confirmed with intelligent classifier system (20) wherein it classifies the audio/video threat object with case base (21). The case base is pre-loaded with variety of complex scenes of incidences.

The cognitive process is programmed with two versions wherein the first version is fixed learning where only pre filled data sets are included the object for threat is assessed only with the fixed cases and the other version is intelligent continuous learning concept where if the device finds any kind of threating object which is not included in the database then it interacts with the user for the conformation of the threat. If the threat is confirmed by the user then the new threat object is added to the case base.

In the decision process (22) of the software the threat level is detected. Upon detection the alert is sent to any known number from the contact of the user and localization process (23) is performed in parallel and finally authenticated information (24) is sent to the appropriate authority.

### Localization:

Localization is the key feature of any context based application. It is fully based on the environment situation and context information that is retrieved from one particular area. This system is based on situations and activities in the environment and the system reacts to the crisis situation in the environment. It will send the alert messages and calls to the nearby node (25) by asking some help. Nodes must have computational and communication capability.

### Message Broadcasting:

Message broadcasting is the next step after localization. Once the locations of the mobile phones are found automatically the alert messages will be broadcasted using broadcasting methods. Messages will be sent using Simple Messaging Service SMS or Multimedia Messaging Service MMS (26). SMS is used to send text information and MMS is used to transfer the multimedia messages.

### Video and Audio Authentication

With the rapid innovation and development in digital technologies, video applications are infiltrating into our daily lives. In some applications the authenticity of video data is of paramount interest such as in video surveillance, forensic investigations, law enforcement and content ownership. It is important to establish the trustworthiness of any video that is used as evidence. Video authentication is a process which ascertains that the content in a given video is authentic and exactly same as when captured. There are four video authentication models viz., Digital Signature, Water mark techniques, Intelligent techniques and other techniques based on motion trajectory, available. This project follows application controlled incidence specific invisible watermark for Video and audio authentication. Watermarking is the process of adding information to the actual video content itself. Often the addition of a watermark is designed such that this, potentially secret, information can be extracted from the video at a later date. A watermark may be designed to be visible, for example for copyrighting, or invisible, for content protection or secret communication. Advantages of Watermarking an image is a matter of personal preference and is not a fool-proof method to protect our images but it will certainly make others think twice before attempting to download and use our image without our consent. Videos transmitted over the communication channel are normally subjected to different types of tampering attacks so watermark is generated and embedded into each frames of the video. After embedding, the frame will be converted into video for transmission over communication channel and on the receiving side; the received video is verified for watermark. If all the frames are watermarked the video is then authenticated otherwise it will be considered/suspected as tampered video. There are different types of watermarking. This work belongs to invisible watermarking type. To keep the watermark unique and secured the program uses the video features of the video for watermarking. The watermark is not restricted with video alone even audio is watermarked in similar method. Watermark can be embedded in an audio signal without being recognized by hearing and the perceptibility requirement is fulfilled. Detection can be done without the availability of the original signal and the watermark.

### Tightly Coupled Non Mobile System (27)

Due to the employment of the modern information and communication technologies the control room environment are going through major changes. When designing the future control rooms it will be important to understand how the new technological enablers change and form the different functions of the control room and the work activities carried out within it. In the existing control rooms, operators utilise multiple software applications and hardware equipment for handling phone calls, operating remote cameras by communicating with other operators, by seeing too much information on screen. Incident management in these control rooms heavily, relies on contacting specific management people and field operator teams to organise major incidents' response.

Tightly coupled non mobile system provides an advanced user interface for incident management system to provide more consistent, integrated and intuitive human-computer interaction and decreases the operator's cognitive load in the control room whereby replacing the tedious stereotyping system followed in control room. Using tightly coupled non mobile system the officer can receive, monitor and operate the meta-information and other evidences if any from the hand held device on a single screen. The awareness of the setup is needed in order to control and superintend the state and course of the process appropriately. The user interface screen comprises of four viewport wherein the audio/video information are displayed with respect to priority of the assistance required. The first view port shows the incidence with higher priority which is needed to be attended immediately and with other three view ports subsequently on a single screen. In addition to the view port the screen displays the coordination point of location of the incident on the local city map along with the information like official personnel employed for duty in the respective location and the date, time of incidence. All the information is regularly documented in a semi automated manner where the documents can be even edited by control room official to append additional information and the final document associated with the case is deposited in a case repository thereby used in future for legal purposes by appropriate agencies like police, forensic, judiciary, etc.

### BRIEF DESCRIPTION OF THE DRAWINGS

FIG. 1 shows the Hardware component of the hand held device

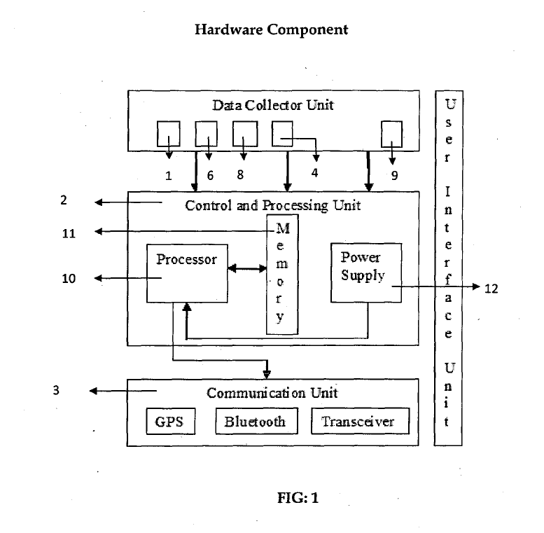

FIG. 2 shows the Process flow chart of the software

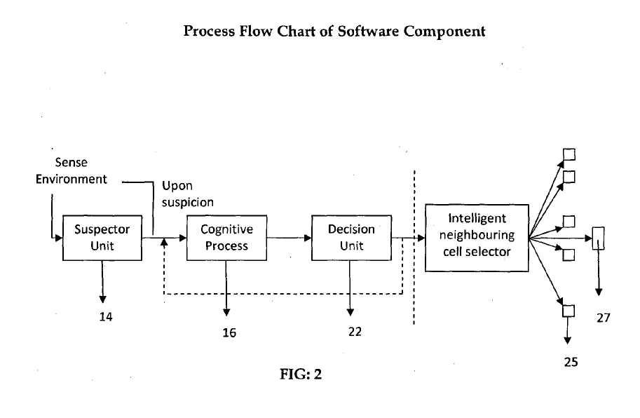

FIG. 3 shows the High level architecture of the software component

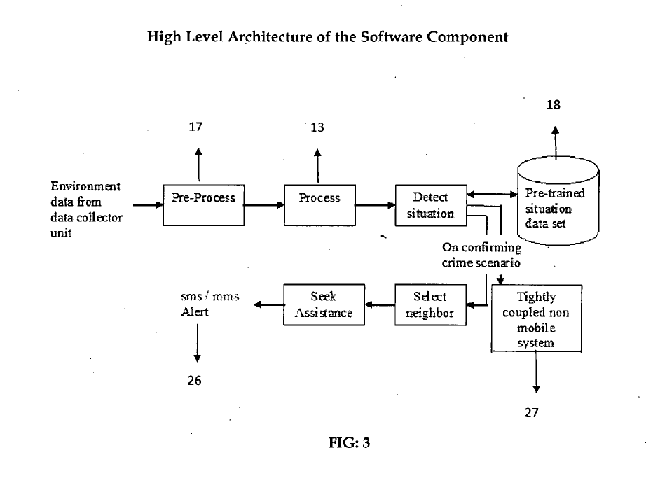

FIG. 4 shows the Data collector unit of the hardware

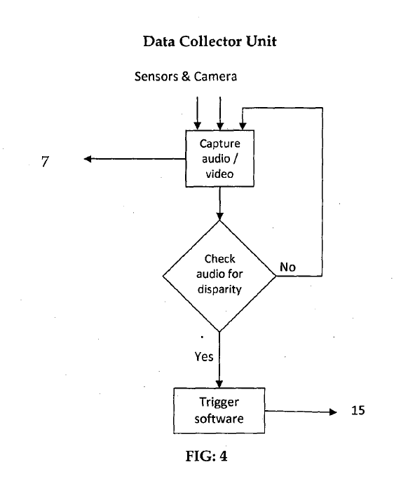

FIG. 5 shows the video process

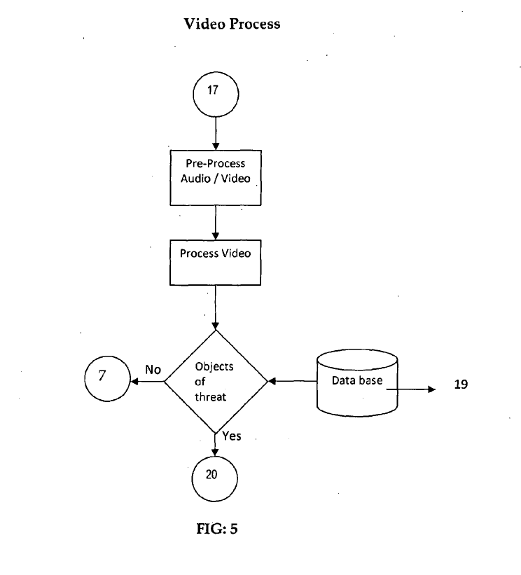

FIG. 6 shows the Audio process

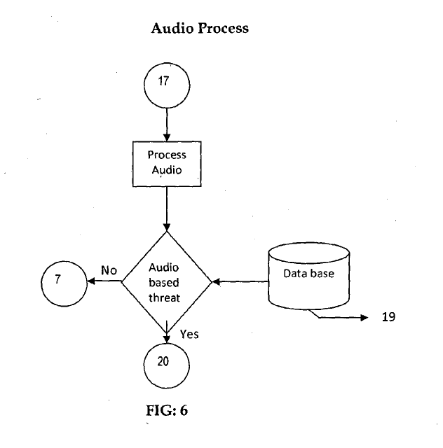

FIG. 7 shows the Intelligent classifier system.

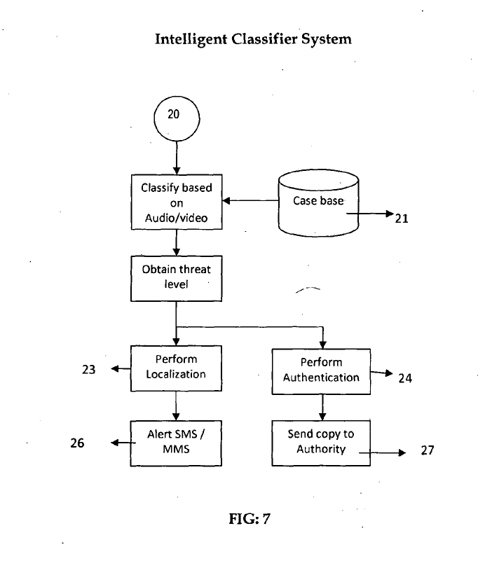

1. An intelligent hand held device that automatically identifies the crime or threat situation comprises of three embodiments,
a) wherein, the said first embodiment is hand held device or enhanced mobile device which comprises of data collector unit, wireless camera, image sensor, global positioning system, timer, date, mode button, mobile network.
b) wherein, the said second embodiment is control and process unit which comprises of suspector unit, cognitive process unit, decision process unit, pre-trained situation dataset, intelligent classifier system, case base, application controlled incidence specific invisible watermark.
c) wherein, the said third embodiment is tightly coupled unit which eventually consist of view port, hotspot for location mapping, meta-information.

2. As claimed in claim 1, wherein the hand held device follows a well established communication network thereby no new network is needed

3. As claimed in claim 1, wherein the data collector unit of hand held device comprises of camera, image sensor, global positioning system, timer, mode button
a) camera continuously records the audio/video recordings along with other meta information's like date, time, global position wherein the night recordings are processed by image sensors for the picture clarity.

4. As claimed in the claim 1, wherein the mode button consisting night/day option and inhouse/exterior environment option to distinguish the environment condition and this can be manually selected.

5. As claimed in claim 1, wherein the said suspector unit which comprises of
a) a process which suspects the threat whereby analysing any disparity in the audio
b) in case of any suspect from the audio then video is processed from the first frame for detection any threats whereby matching with prejudicial video objects from the pre-trained situation dataset
c) the audio is also processed in parallel similar to video process for detection of any threat whereby matching with prejudicial audio objects from the pre-trained situation dataset
d) the whole process is repeated if the object of threat is absent whereas in case of any threat detected then it is further processed to cognitive process unit.

6. As claimed in claim 1, wherein cognitive process unit comprises of
a) intelligent classifier system wherein the threat objects are classified with case base
b) the case base is trained with different complex scenarios

7. As claimed in claim 1, wherein the cognitive process unit comprises of two version continuous learning and fixed learning
a) wherein continuous learning process the system continuously learns new objects whereby manual intervention with the user.
b) wherein fixed learning is the pre-loaded case base

8. As claimed in claim 1, wherein the decision process unit comprises of process for threat level detection, process to perform localization, process to perform authentication
a) wherein the process for threat level is detected and prioritized accordingly
b) the process is executed in two embodiments wherein the first embodiment the intelligent hand held device seeks immediate help from any known person from the contact list wherein, the second embodiment is the localisation where the alert messages and calls are sent to nearby unknown node for seeking help
c) wherein the process to perform authentication the intelligent hand held device provide evidences like audio/video objects, date, time, global positioning of the crime or threat scene to the appropriate tightly coupled non mobile system or authority
d) the evidences comprising of audio/video objects are provided with application controlled incident specific invisible watermarks

9. As claimed in the claim 1, wherein the tightly coupled system comprises of
a) multiple viewport displaying the incidence in single monitor wherein the first viewport showing higher prior incidence and following that other view ports displays the incidence subsequently.
b) in addition to the viewports two more windows are displayed wherein one window shows the hotspot for location on the map and another window displays the information comprising of time, positions of official personnel's near the crime or threat scene

10. As claimed in the claim 1, wherein the information collected by this process is non-editable and the process only decides the threat level and provides evidences to the tightly coupled non mobile system and rest of the information collected are automatically deleted.
